(19) United States
(12) Patent Application Publication
(10) Pub. No.: US 2017/0206111 A1
(43) Pub. Date: Jul. 20, 2017

(54) MANAGING PROCESSING CAPACITY PROVIDED TO THREADS BASED UPON LOAD PREDICTION

(71) Applicant: Qualcomm Innovation Center, Inc., San Diego, CA (US)

(72) Inventor: Saravana Krishnan Kannan, San Diego, CA (US)

(21) Appl. No.: 15/272,657

(22) Filed: Sep. 22, 2016

Related U.S. Application Data
(60) Provisional application No. 62/279,495, filed on Jan. 15, 2016.

(51) Int. Cl. G06F 9/50; G06F 9/48

(52) U.S. Cl. CPC G06F 9/505; G06F 9/4881

(57) ABSTRACT

A method and device for managing processing capacity are disclosed. The method includes creating, for a thread, a plurality of buckets, each of the buckets representing one of a plurality of normalized-load ranges. The method also includes obtaining a short-term-normalized-processing-load for the thread and collecting long-term historical load data for the thread by increasing a count in a particular bucket of the plurality of buckets that has a normalized-load range that includes the short-term-normalized-processing-load and decreasing a count in all other buckets of the plurality of buckets. A load for a thread is predicted based on, at least, an immediate load and the count in each of the plurality of buckets. The predicted load is then used to manage processing capacity provided to process the thread.

### CLAIM OF PRIORITY UNDER 35 U.S.C. §119

The present Application for Patent claims priority to Provisional Application No. 62/279,495 entitled “LOOK-AHEAD PROCESSOR FREQUENCY SCALING” filed Jan. 15, 2016, and assigned to the assignee hereof and hereby expressly incorporated by reference herein.

### BACKGROUND

### Field

The presently disclosed embodiments relate generally to computing devices, and more specifically, to managing processing capacity provided to threads running on computing devices.

### Background

Computing devices including devices such as smartphones, tablet computers, gaming devices, and laptop computers are now ubiquitous. These computing devices are now capable of running a variety of applications (also referred to as “apps”) and many of these devices include multiple processors to process tasks that are associated with apps. In many instances, multiple processors are integrated as a collection of processor cores within a single functional subsystem. It is known that the processing load on a mobile device may be apportioned to the multiple cores. Some sophisticated devices, for example, have multiple core processors that may be operated asynchronously at different frequencies. On these types of devices, the amount of work that is performed on each processor may be monitored and controlled by a frequency governor to meet workloads.

In general, the goal of CPU frequency scaling is to provide just enough CPU frequency to meet the needs of the work load on the CPU. This ensures adequate performance without wasting power and allows for a good performance to power ratio. The Linux operating system for example, may use an interactive governor, which monitors the workload on each processor and adjusts the corresponding clock frequency based on the workload.

Existing CPU load prediction and CPU frequency selection algorithms have some heuristics for quickly increasing the CPU frequency in case the workload needs maximum CPU capacity. These heuristics are generally tuned to make conservative changes to CPU frequency to avoid adversely impacting the power or performance metric when the prediction by the heuristic ends up being wrong. Existing CPU frequency selection algorithms can improve both in power and performance metrics if they can do a better job at predicting the future CPU load.

A significant portion of the error in the prediction (and the conservative changes to CPU frequency that come along with it) comes from the fact that most algorithms only look at the immediate history (e.g., 10 ms-100 ms) and completely ignore the longer historical behavior and data (e.g., seconds to days). Another contribution to the prediction error is that most algorithms assume that the same threads or tasks that ran in the immediate past will continue to run in the immediate future.

### SUMMARY

Aspects may be characterized as a method for managing processing capacity on a computing device. The method includes creating, for a thread, a plurality of buckets, each of the buckets representing one of a plurality of normalized-load ranges. A short-term-normalized-process sing-load for the thread is obtained, and then long-term historical load data for the thread is collected by increasing a count in a particular bucket of the plurality of buckets that has a normalized-load range that includes the short-term-normalized-processing-load and decreasing a count in all other buckets of the plurality of buckets. A load for a thread is predicted based on, at least, an immediate load and the count in each of the plurality of buckets. The predicted load is used to manage processing capacity provided to process the thread.

Another aspect includes a computing device including a plurality of processors, a scheduler configured to schedule threads for execution by the plurality of processors and a load prediction module configured to provide a predicted load value. The load prediction module includes a short-term load recorder configured to collect short-term-normalized-processing-load data for each of a plurality of threads; a bucket generator configured to generate a plurality of buckets, each of the buckets representing a normalized-load rang; a long-term load recorder configured to collect for each thread, long-term historical load data by increasing a count in a particular bucket each time the short-term-normalized-processing-load falls within a range of the particular bucket and decreasing a count in all other buckets of the plurality of bucket; and an anticipated load module configured to predict a load based on an immediate load and the count in each of the plurality of buckets. The computing device also includes an operating system configured to use the predicted load to manage processing capacity provided to process the thread.

### BRIEF DESCRIPTION OF THE DRAWINGS

FIG. 1 is a block diagram of a computing device;

FIG. 2 is a block diagram depicting components of the load prediction module of FIG. 1;

FIG. 3 is a flowchart depicting a method for maintaining long-term historical load data about threads;

FIG. 4 is a drawing depicting an example of long-term historical load data changing over time;

FIG. 5 is a drawing depicting another example of long-term historical load data changing over time;

FIG. 6 is a flowchart depicting a method for computing the predicted load of a thread; and.

FIG. 7 is a block diagram depicting hardware components that may be used to realize the computing device depicted in FIG. 1.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

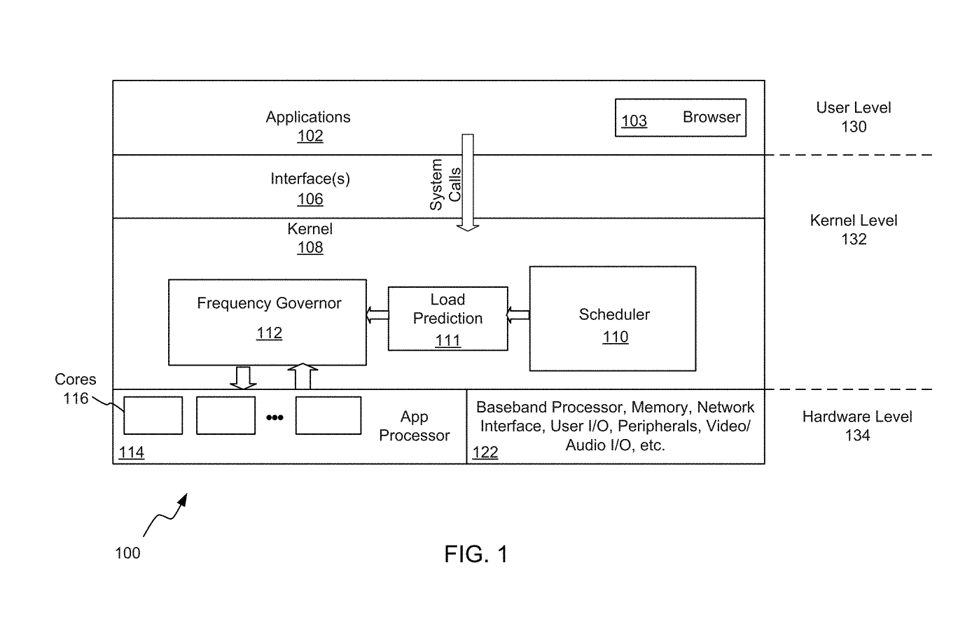

Referring to FIG. 1, it is a block diagram illustrating components of a computing system 100 (also referred to herein as a computing device 100). The block diagram includes applications 102 (e.g., a web browser 103) at the highest level of abstraction and hardware such as the applications processor 114, which includes a plurality of processor cores 116, at the lowest level. The kernel 108, along with interface 106, enable communication between the applications 102 and the app processor 114. In particular, the interface 106 passes system calls from the applications 102 to the kernel 108. Also shown is a scheduler 110 that is coupled to a load prediction module 111, and the load prediction module 111 is coupled to a frequency governor 112 (also referred to herein as the governor 112 or processor governor 112). Although the specific embodiment depicted in FIG. 1 depicts multiple processor cores 116 within an app processor 114, it should be recognized that other embodiments include a plurality of processors that are not integrated within the app processor 114. As a consequence, the operation of multiple processors is described herein in the context of both multiple processor cores 116, and more generally, multiple processors, which may include processor cores and discrete processors. As used herein, the term processor generally refers to both processor cores 116 and central processing units (CPUs), such as the app processor 114, which may have multiple cores.

As one of ordinary skill in the art will appreciate, the user level 130 and kernel level 132 components depicted in FIG. 1 may be realized by hardware in connection with processor-executable code stored in a non-transitory tangible processor readable medium such as nonvolatile memory, and can be executed by app processor 114. Numerous variations on the embodiments herein disclosed are also possible.

The one or more applications 102 may be realized by a variety of applications that operate via, or run on, the app processor 114. For example, the one or more applications 102 may include a web browser 103 and associated plug-ins, entertainment applications (e.g., video games and video players), productivity applications (e.g., word processing, spread sheet, publishing applications, video editing, photo editing applications), core applications (e.g., phone and contacts apps), and augmented reality applications. In connection with running the applications 102, threads are executed by the app processor 114.

As one of ordinary skill in the art will appreciate, among other functions, the scheduler 110 (also referred to herein as a scheduling component 110) operates to schedule threads among the processor cores 116 to balance the load that is being processed by the app processor 114. In general, the frequency governor 112 utilizes information from the scheduler 110 to arrive at one or more frequencies and voltages for the app processor 114.

In prior art implementations, CPU load prediction and CPU frequency selection algorithms have some heuristics for quickly increasing the CPU frequency in case the scheduled workload needs a maximum CPU capacity. But these heuristics are generally tuned to make conservative changes to CPU frequency to avoid adversely impacting the power or performance metric when the prediction by the heuristic ends up being wrong. A significant portion of the error in the prediction (and the conservative changes to CPU frequency that come along with it) comes from the fact that most algorithms only look at the immediate history (e.g., 10 ms-100 ms) and completely ignore the longer historical behavior and data (e.g., seconds to days). Another contribution to the prediction error is that most algorithms assume that the same threads or tasks that ran in the immediate past will continue to run in the immediate future.

But in this embodiment, the frequency governor 112 operates to govern frequencies of the processor cores 116 based, at least in part, upon a predicted load provided by the load prediction module 111. As discussed in more detail further herein, when generating the predicted load, the load prediction module 111 may look beyond the immediate load history and also factor in (to its predicted load calculation) the specific threads that are scheduled by the scheduler 110. As used herein, the term load is defined to be a percent of time a thread is running during a sample duration for a given processor frequency. For example, a thread running for 15 milliseconds of a 20 millisecond sample duration exerts a load of 75%. The load may be normalized as discussed further herein.

Utilizing the predicted load, the frequency governor 112 operates to adjust the operating frequency of each of the processor cores 116 based upon the predicted work that will be performed. If a particular one of the processor cores 116 has a heavy load, the frequency governor 112 may increase a frequency of the particular processor core. If another processor core has a relatively low load or is idle, the frequency of that processor core may be decreased (e.g., to reduce power consumption). As described further herein, the frequency governor 112 may receive a variety of information that it uses in connection with controlling and adjusting the frequencies of the cores 116—including the predicted load information from the load prediction module 111. The frequency governor 112 can then control (e.g., adjust) the operating frequency of the processor cores 116 based, at least in part, on the predicted load. Although not required, the frequency governor 112 may be realized by modified versions of the following non-exclusive list of governors: interactive, conservative, ondemand, userspace, powersave, and performance.

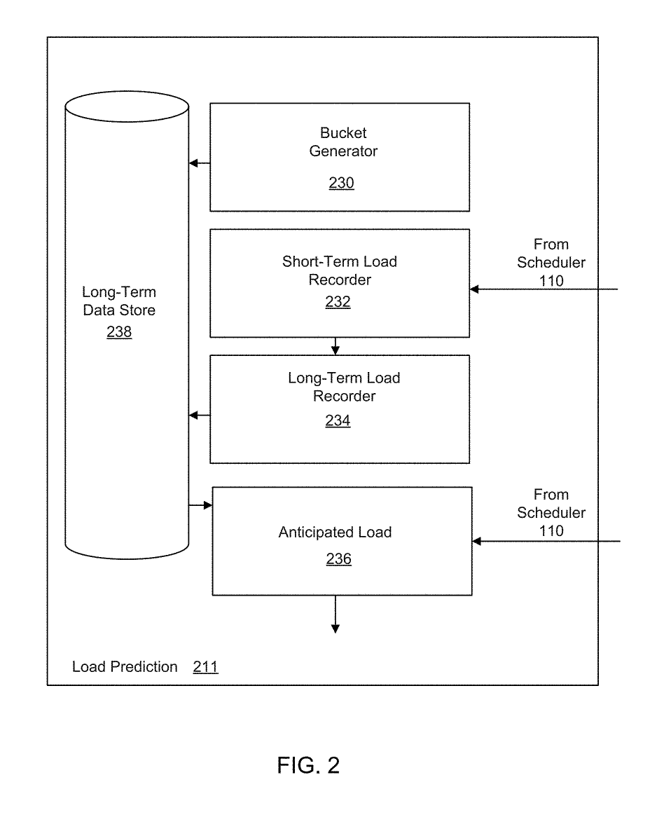

Referring next to FIG. 2, shown is a block diagram depicting an exemplary load prediction module 211, which may be used to realize the load prediction module 111 depicted in FIG. 1. As shown, the load prediction module 211 includes a bucket generator 230, a short-term load recorder 232, a long-term load recorder 234, an anticipated load module 236, and a long-term data store 238, which may be realized by RAM. The division of components depicted in FIG. 2 is intended to depict functional aspects of the load prediction module 111—it is not intended to depict a division of hardware or software components. Thus, in actual implementation, the functions described with reference to FIG. 2 may be implemented by hardware and/or software with components that are integrated and/or further divided than those components depicted in FIG. 2. Moreover, it should be recognized that the functions of the load prediction module 211 may be distributed among components of the operating system of the computing device 100. For example, functions of the load prediction module 211 may be distributed between the scheduler 110 and the frequency governor 112.

### Collecting Short Term Data

As shown in the depicted embodiment, the short-term load recorder 232 is disposed to receive information from the scheduler 110 about each of a plurality of threads that are scheduled and collect short-term-normalized-processing-load data for each of the plurality of threads. More specifically, for every thread (this includes tasks and processes), the short-term load recorder 232 keeps track of an immediate load a thread imposes on processing resources (e.g., the processor cores 116 of the app processor 114). The immediate load can be tracked in multiple ways, including, but not limited to one of the following: measuring, using a “windowing” technique, how long a thread ran in a sample duration (e.g., a window of N milliseconds) (e.g., every 10 or 20 milliseconds) and in an alternative “continuous” technique tracking a “continuous” load value that gradually accumulates every unit of time a thread runs (or is runnable) and gradually decays every unit of time the thread sleeps.

Using the “windowing” technique, short-term-normalized-processing-load data may be generated by doing the following every sample duration of N milliseconds: for every thread that ran in the past N milliseconds, an immediate load of the thread is sampled, and this immediate load of the thread is normalized as a percentage of the maximum performance point of the computing device 100. The maximum performance point of computing device 100 may be the highest performance point possible on the most performant processor in the computing device 100. As an example, the highest performance point of a processor may be the processor's maximum frequency, and the most performant processor may be the processor that operates at a highest frequency. For every thread, the last H normalized loads are stored.

By way of further example, if the most performant processor is capable of operating at a frequency of 2 GHz, and a thread is executed on a less performant processor (capable of operating at 1 GHz) during 50% of a window (of N milliseconds) then the short-term-normalized-processing-load of the thread is 25%. In addition, the normalization may include normalizing across CPU architecture types at their highest frequency. For example, a thread processed on a more performant CPU architecture may complete execution of the thread sooner than a lower performant CPU architecture.

### Collecting Long Term Historical Data

In the embodiment depicted in FIG. 2, the bucket generator 230 functions to create, for each of the plurality of threads, a plurality of buckets, wherein each of the buckets represents a normalized-load range. In general, the long-term load recorder 234 is configured to collect for each thread, long-term historical load data by increasing a count in a particular bucket each time the processing load for a thread falls within a range of the particular bucket during a sample duration. According to an aspect, if a processing load does not fall within the range of a particular bucket during a sample duration, the count in that particular bucket is decreased.

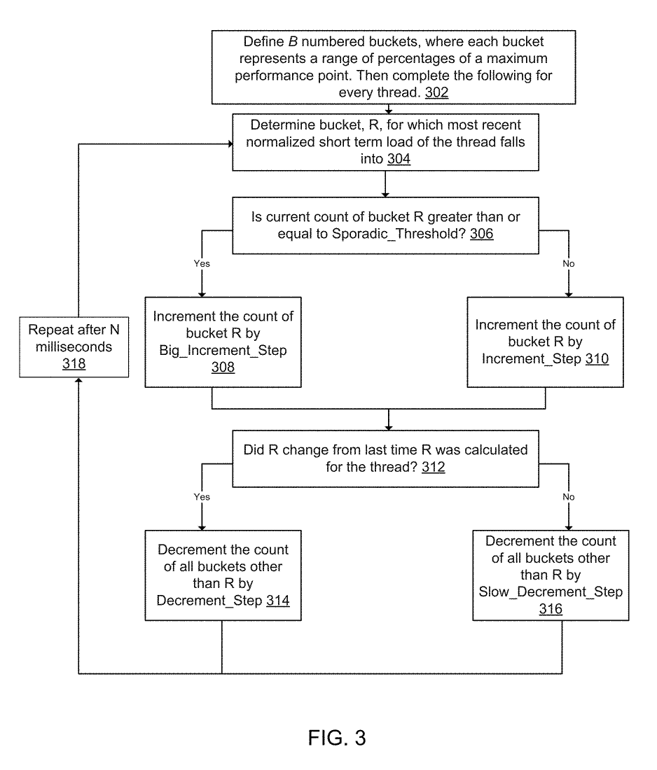

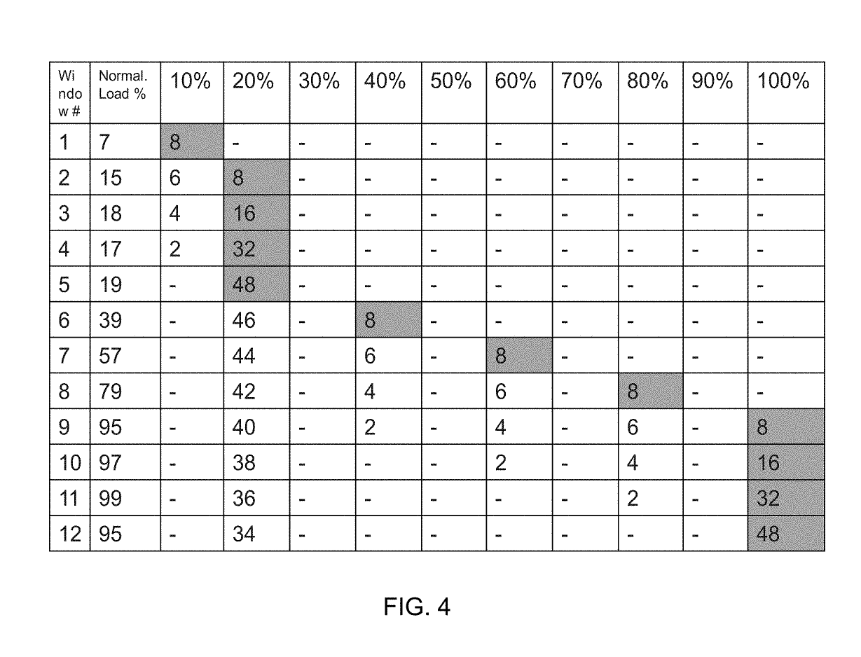

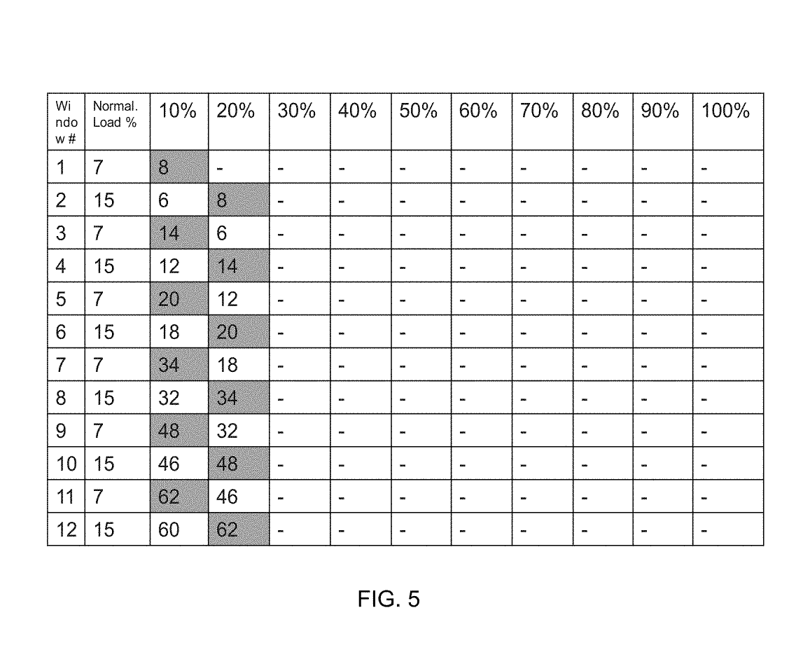

According to another aspect, once the count in a bucket crosses a threshold, the count may grow faster or stay non-zero for longer. For example, when the count in a particular bucket crosses a count threshold (also referred to herein as a sporadic threshold), the increment value for the count in that particular bucket may be increased. The method described with reference to FIG. 3 (in connection with FIGS. 4 and 5) uses a greater increment value when a count threshold is reached. But in alternative implementations, the count decrement value for the particular bucket may be decreased when the count threshold is reached. Using either of these two approaches, the count grows faster (or stays non-zero for longer) when the count threshold is reached.

Referring next to FIG. 3 while simultaneous reference is made to FIG. 2, shown is a flowchart depicting a method for generating long-term historical load data. As shown in FIG. 3, the bucket generator 230 may split a maximum performance point into B numbered buckets, with each bucket representing a range of percentages of the maximum performance point (Block 302). For example, bucket 0=0-20%; 1=20-30%; 2=30-40%, 9=90-100%. For every thread, a heat map or decaying histogram of the load may be maintained in terms of the B buckets of the maximum performance point. According to an aspect, the bucket ranges may be dynamically configured.

When selecting bucket ranges, a size of the lowest bucket may be selected to be at least large enough to accommodate the lowest performance point of the system, but the B buckets of the maximum performance point of the system do not need to be of equal percentage ranges. For example, bucket ranges of: 0-20%, 20-30%, 30-40%, 40-50%, 90-100% could be selected.

In systems where every CPU is of the same architecture and supports the same frequency points, it may be beneficial to align the bucket ranges to coincide with the percentages that correspond to the actual frequencies supported by the CPUs.

In systems where the CPUs are of different architectures or support different performance points, it may not help to align the buckets with the actual performance points because, if the bucket range is normalized to the maximum performance point of the system, aligning the buckets to the performance points of one CPU can have a negative impact on prediction for the other CPU types.

The long-term load recorder 234 generally functions to collect, for each thread, long-term historical load data by increasing a count in a particular bucket each time the processing load for a corresponding thread falls within a range of the particular bucket. As shown in FIG. 2, the resultant long-term historical-load data may be stored (in the form of a histogram) in the long-term data store 238.

Referring again to FIG. 3, the histogram may be maintained by performing the operations depicted with reference to Blocks 304-318 during a sample window for every thread that ran in the sample window. While referring to FIG. 3, simultaneous reference is made to FIGS. 4 and 5. Each of FIGS. 4 and 5 depict multiple snapshots of a histogram as time progresses. FIG. 4 is a histogram that depicts long-term historical load data for a thread that presents a relatively light load followed by a relatively heavy load. FIG. 5 is a histogram that depicts long-term historical load data for a thread that presents a load that is a relatively light load. The buckets with a zero count are depicted with a dash “-.”

Initially a bucket, R, is determined where R is the bucket the most-recent short-term-normalized-processing-load of the thread falls into (Block 304). In FIGS. 4 and 5, the bucket, R, is shown as a shaded bucket in each snapshot. As shown, if a current count of bucket R is greater than or equal to a sporadic threshold (Sporadic_Threshold) (Block 306), then a count of the bucket R is increased by a big increment step (Big_Increment_Step) (Block 308). Otherwise, the count of bucket R is increased by an increment step (Increment_Step) (Block 310). In other words, the count is increased by the increment step until the count reaches the sporadic threshold. For purposes of examples below, the sporadic threshold is 16, the big increment step is 16, and the increment step is 8, but each of these values may vary up or down and may be non-integer values (e.g., rational or irrational numbers) without departing from the scope of the claims. The count of each bucket can additionally be utilized in order to predict a load, as will be disclosed further herein.

For all other buckets other than R, if R didn't change from the last time R was calculated for the thread (Block 312), the count is decremented by a slow decrement step (Slow_Decrement_Step) (Block 316); otherwise, the count is decremented by a decrement step (Decrement_Step) (Block 314). In some implementations, the slow decrement step (Slow_Decrement_Step) is set to be the same as the decrement step (Decrement_Step). In the examples below, the slow decrement step (Slow_Decrement Step) and the decrement step (Decrement_Step) are set to 2. In the embodiment depicted in FIG. 2, the long-term historical load data is stored in the long-term data store 238.

As shown in FIG. 4, after the first window, the normalized load of the thread is calculated to be 7%; thus the 0-10% bucket is incremented to 8. And after the second and third windows (where the normalized loads were 15 and 18%, respectively), the counter in the 11-20% bucket was incremented by 8 after each of the second and third windows so that after the third window the count in the 11-20% bucket is 16. But after the fourth window (where the normalized load was 17%), the 11-20% bucket is incremented by the big increment step to 32. As depicted, after each of windows 2-4, the count in the 0-10% bucket was decremented by 2 because R was the 11-20% bucket after each of windows 2-4. The resultant counts in FIG. 4 (34 in the 11-20% bucket and 48 in the 91-100% bucket) convey that the thread generally runs (for a maximum CPU frequency) either a short period of time or a long period of time.

As shown in FIG. 5, the normalized processing load of a thread alternates between 7 and 15%; thus the count in each of the 0-10% and 11-20% buckets alternately increases and decreases so that after 12 windows, the counts in the 0-10% and 11-20% buckets are 60 and 62, respectively, which is indicative of a thread load that is consistently, relatively small.

Predicting a Load for each Processor

In general, the anticipated load module 236 calculates the predicted load of a processor based on an immediate load and the long-term historical load data. For example, the predicted load of a processor may be calculated as a sum of the predicted load of all the runnable or running threads in the processor. In some variants, the predicted load of the sleeping threads can also add to the predicted load of a processor.

The predicted load of a particular thread is computed using the normalized immediate load of the particular thread. It should be noted that the immediate load of a thread can be different from the most recent short-term-normalized-processing-load of the thread if the immediate load is sampled in between two short term historical load sampling points.

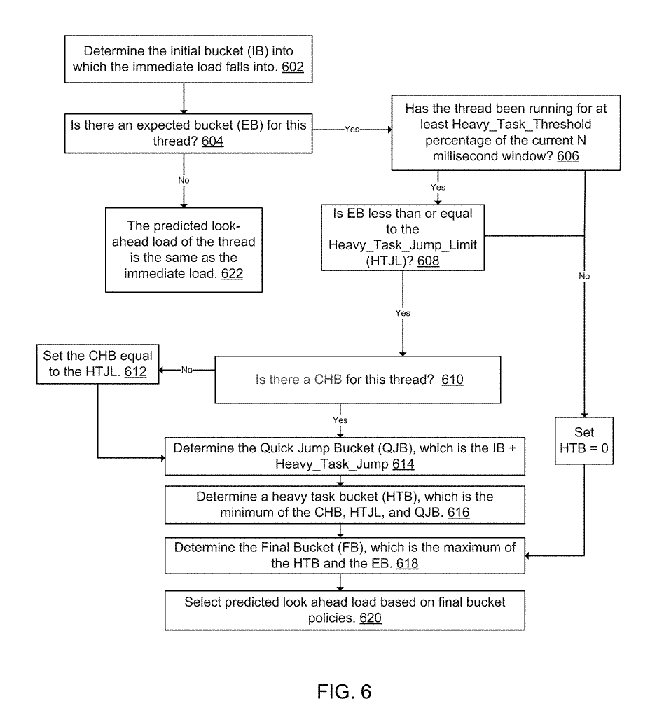

Referring to FIG. 6, shown is a flowchart that depicts a method for calculating a predicted load of a thread. The predicted load may be recomputed (Blocks 602-620) at least every sample duration (e.g., every N milliseconds). The predicted load of a processor can also be recomputed in response to a triggering event. An example triggering event may be a change in the list of running or runnable (or sleeping, in some variants) threads on the processor.

As shown, an initial bucket (IB) into which the immediate load falls into is determined (Block 602), and an expected bucket (EB) is set as a lowest bucket that has a non-zero count and is greater than or equal to IB (Block 604). If no such EB bucket is found, the predicted load is the same as the immediate load (Block 622).

But if an EB is found, and if the thread has been running for at least a heavy task threshold percentage (Heavy_Task_Threshold) (e.g., 85%) of the current sample duration (or the last sample duration in some variants), which indicates there is a CPU-frequency-bottleneck (Block 606), and EB is less than or equal to a heavy task jump limit (Heavy_Task_Jump_Limit) (HTJL) (Block 608), then a consistent higher bucket (CHB) is computed by finding the lowest bucket that is greater than IB and has a count that is greater than or equal to the sporadic threshold (Sporadic_Threshold) (Block 610). If none are found, then CHB is set equal to HTJL (Block 612). As shown, a quick jump bucket (QJB) variable is set to equal IB+a heavy task jump (Heavy_Task_Jump) where the heavy task jump is a number of buckets (load ranges) set (e.g., two buckets, but this is a tunable number) to quickly arrive at a higher predicted load range (to remove the CPU-frequency-bottleneck) (Block 614), and a heavy task bucket (HTB) is the minimum of CHB, Heavy_Task_Jump_Limit and QJB (Block 616). But if an EB is found, and if the thread has not been running for at least a heavy task threshold percentage (Heavy_Task_Threshold) (e.g., 85%) of the current sample duration (or the last sample duration in some variants), then HTB is set to 0. A final bucket (FB) is then computed as a maximum of HTB and EB (Block 618).

The predicted load (also referred to as a predicted load value) is then selected to fall within the FB load range using policies such as, but not limited to: the most recent (or minimum, maximum, average, etc.) value in the H short-term-normalized-processing-load data that falls within the FB and if none found, the average (minimum, maximum, etc.) of the FB range, etc. (Block 620).

For example, in a case with an alternating small and large load on a processor, similar to the case of FIG. 4, some sample resultant counts on buckets could be 64 on 0-10%, 64 on 10-20%, and 24 on 90-100%. In this example, the HTJL will be set to the 40-50% bucket, and the normalized immediate load may be 25%, so that the IB is the 20-30% bucket. Thus, the EB is the 90-100% bucket because that is the next lowest bucket with a count in it (the EB in this case is not the same as the IB because the IB bucket 20-30% has a 0 count). The CHB, QJB, HTB, all do not exist since the EB is greater than the HTJL. The FB is then also the EB because the HTB does not exist. Thus, the predicted load may fall anywhere in the FB range based on the factors mentioned herein; so for example 95% may be the predicted load if the average of the FB range were to be a factor in deciding the predicted load. This example shows that the prediction methodology disclosed herein quickly scales the CPU to its maximum frequency (in contrast to the prior art which would take multiple, gradual steps before finally arriving at the maximum frequency).

As another example, in a case with a consistently small task, similar to the case of FIG. 5, some sample resultant counts could be 40 in the 0-10% bucket and 40 in the 10-20% bucket. In this example the HTJL will be set to the 40-50% bucket, and the heavy task jump will be set to 2. The normalized immediate load of the thread may be 9%, and the thread is running for at least 90% of the time of the sample duration, so that the IB is the 0-10% bucket and the thread's runtime has exceeded the heavy task threshold. Thus the EB is also the 0-10% bucket because that is the next lowest bucket equal to or greater than the IB that has a count in it. Because the heavy task threshold condition has been met, the steps described with reference to Blocks 608-618 are carried out to determine whether the predicted load should be set to be greater than the load range of the expected bucket. This determination is made based on the counts in each of the plurality of buckets with a load range that is greater than that of the expected bucket. The CHB (Block 610) is the 10-20% bucket since this bucket surpasses the example sporadic threshold (16), and is the next greater bucket from the IB. The QJB (Block 614) is the 20-30% because the heavy task jump is set to 2, and the 20-30% bucket is 2 buckets higher than the IB. The HTB (Block 616) is the 10-20% bucket because that is the minimum of the CHB (10-20%), HTJL (40-50%), and QJB (20-30%). Finally, the FB (Block 618) is also the 10-20% bucket because that is the maximum of the EB (0-10%) and the HTB (10-20%). In this case, if there is short-term-normalized-processing-load data that fell within the 10-20% bucket, this may be used as the predicted load; otherwise the predicted load could be 15%, if the average of the FB was used as a policy for deciding the predicted load. This example shows that the prediction methodology disclosed herein will avoid significantly increasing the CPU frequency (despite the thread appearing to be bottlenecked by the CPU frequency) in contrast to the prior art, which would increase the CPU frequency to an unnecessarily high level. For instance, the methods of the present disclosure may result in a frequency of 500 MHz and the prior art approaches may result in a frequency of 1 GHz.

Early Notification from Scheduler

An additional enhancement to the embodiments disclosed herein is to configure the scheduler 110 to keep track of the last predicted load that was reported for use by the frequency governor 112.

If the predicted load differs significantly, then the scheduler 110 can send a notification to the frequency governor 112 to enable the frequency governor 112 (e.g., using a dynamic clock and voltage scaling (DCVS) algorithm) to re-compute the processor frequency immediately instead of waiting for any timer to expire. This will typically happen when many threads wake up or migrate, or when a single big thread wakes up or migrates.

### Using the Predicted Load

Once generated, the predicted load value is used (at least in part) to adjust the frequency of the processors on the computing device 100. The DCVS algorithm employed by the frequency governor 112 may use only the predicted load value or use both the predicted load value and the legacy load (e.g., a load value from existing load predicting mechanism) to decide the final frequency of the processor frequency.

One way of combining the predicted load and the legacy load is to determine the processor frequency independently for the predicted load and the legacy load and pick the maximum of the two computed processor frequencies.

But when the processor frequency computed from the predicted load is greater than the processor frequency computed from the legacy load, the DCVS algorithm can skip all legacy processor frequency scaling heuristics (hysteresis timers, etc.) that prevent the processor frequency from reducing once the load goes away. Those heuristics are only needed when the load prediction is not very good.

In some implementations, the legacy heuristics related to aggressively increasing the processor frequency for heavy loads may always be skipped. This is because the predicted load already recognizes heavy loads at a thread level and aggressively predicts an even higher load only when there is a high probability for the thread's load to increase. Using the legacy heuristics in this case would unnecessarily waste power without giving a worthy performance benefit.

Another approach is to simply use only the predicted load to compute the final processor frequency. In this case, a variant of this idea that includes predicted load of sleeping threads in computing the processor's predicted load will have to be used to avoid incorrect processor frequency changes when threads sleep and wake up frequently. The DCVS algorithm may only take the predicted load and use a load-to-processor-frequency curve to decide the processor frequency without applying any additional hysteresis or heuristics.

Using this histogram based load prediction algorithm can significantly reduce the time taken for the processor to ramp up from the lowest to the highest frequency when a big task goes to sleep and wakes up. This significant reduction in time taken for the processor to ramp up from the lowest to the highest frequency also applies in the context of an alternating tiny-big-type task changing from a tiny-type of operation to a big-type of operation.

The time to ramp up for such a case can go down from ˜120-140 ms (6-7 sample durations of 20 ms each) to about 10-40 ms (½ to 2 sample durations of 20 ms each). This can bring noticeable improvement in performance for real world use cases like reducing user interface latencies, reducing janks, etc.

The logic described above to address a CPU-frequency-bottleneck scenario also avoids unnecessarily aggressive processor frequency increases that happen in legacy processor frequency scaling mechanisms. For example, during a CPU-frequency-bottleneck scenario, the legacy mechanisms are prone to mistake a consistently small thread that needs just a little bit more processor capacity (e.g., when a thread's normalized load changes from 9% to 11%) for a thread that truly has a high demand (e.g., a normalized load of 70%) for a processor because they can't differentiate between a consistently tiny tasks vs alternating tiny/big tasks or big tasks. Handling this correctly also gives non-trivial power savings for real world use cases.

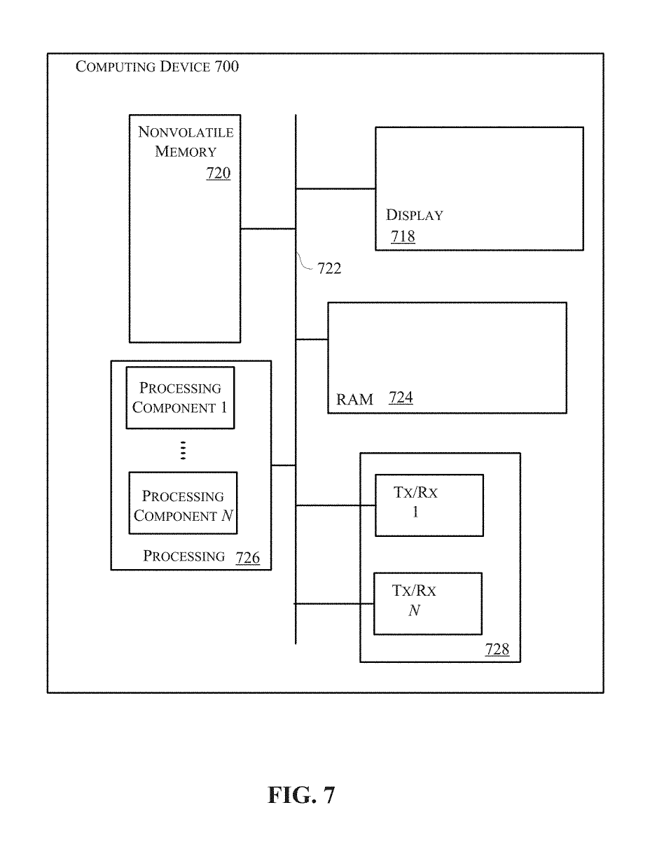

Referring next to FIG. 7, shown is a block diagram depicting physical components of an exemplary computing device 700 that may be utilized to realize the computing device 100 described with reference to FIG. 1. As shown, the computing device 700 in this embodiment includes a display 718, and nonvolatile memory 720 that are coupled to a bus 722 that is also coupled to random access memory (“RAM”) 724, N processing components 726, and a transceiver component 728 that includes N transceivers. Although the components depicted in FIG. 7 represent physical components, FIG. 7 is not intended to be a hardware diagram; thus many of the components depicted in FIG. 7 may be realized by common constructs or distributed among additional physical components. Moreover, it is certainly contemplated that other existing and yet-to-be developed physical components and architectures may be utilized to implement the functional components described with reference to FIG. 7.

The display 718 generally operates to provide a presentation of content to a user, and may be realized by any of a variety of displays (e.g., CRT, LCD, HDMI, micro-projector and OLED displays). And in general, the nonvolatile memory 720 functions to store (e.g., persistently store) data and executable code including code that is associated with the functional components depicted in FIG. 1. In some embodiments for example, the nonvolatile memory 720 includes bootloader code, modem software, operating system code, file system code, and code to facilitate the implementation of one or more portions of the computing device discussed in connection with FIG. 1 as well as other components well known to those of ordinary skill in the art that are not depicted nor described in connection with FIG. 1 for simplicity.

As discussed above, the nonvolatile memory 720 is realized by flash memory (e.g., NAND memory). Although it may be possible to execute the code from the nonvolatile memory 720, the executable code in the nonvolatile memory 720 is typically loaded into RAM 724 and executed by one or more of the N processing components 726.

The N processing components 726 in connection with RAM 724 generally operate to execute the instructions stored in nonvolatile memory 720 to effectuate the functional components depicted in FIGS. 1 and 2. As one of ordinarily skill in the art will appreciate, the N processing components 726 may include an application processor, a video processor, modem processor, DSP, graphics processing unit (GPU), and other processing components.

The transceiver component 728 includes N transceiver chains, and each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, or hardware in connection with software. Various illustrative components, blocks, modules, circuits, and steps have been described above generally in terms of their functionality. Whether such functionality is implemented as hardware or hardware that utilizes software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for managing processing capacity on a computing device, the method comprising:
creating, for a thread, a plurality of buckets, each of the buckets representing one of a plurality of normalized-load ranges;
obtaining a short-term-normalized-processing-load for the thread;
collecting long-term historical load data for the thread by increasing a count in a particular bucket of the plurality of buckets that has a normalized-load range that includes the short-term-normalized-processing-load and decreasing a count in all other buckets of the plurality of buckets;
predicting a load for a thread based on, at least, an immediate load and the count in each of the plurality of buckets; and
using the predicted load to manage processing capacity provided to process the thread.

2. The method of claim 1, wherein obtaining the short-term-normalized-processing-load data includes determining a load of the thread during a sample duration.

3. The method of claim 1, wherein obtaining the short-term-normalized-processing-load data includes keeping a continuous load value that gradually accumulates every unit of time a thread is runnable and gradually decays every unit of time the thread sleeps.

4. The method of claim 1, wherein an amount of increase and an amount of decrease for the particular bucket is based upon the count in the particular bucket.

5. The method of claim 1, wherein predicting a load based on an immediate load and the long term historical data includes:
determining an initial bucket the immediate load falls into;
attempting to identify an expected bucket that is a lowest bucket that has a non-zero count and is greater than or equal to the initial bucket;
if no expected bucket is found, then selecting the immediate load as the predicted load;
if an expected bucket is found, then setting the predicted load to at least a load that falls within the expected bucket.

6. The method of claim 5,
wherein setting the predicted load includes setting the predicted load to be greater than the load range of the expected bucket based on the counts in each of the plurality of buckets with a load range that is greater than that of the expected bucket.

7. A computing device comprising:
a plurality of processors;
a scheduler configured to schedule threads for execution by the plurality of processors;
a load prediction module configured to provide a predicted load value, the load prediction module includes:
a short-term load recorder configured to collect short-term-normalized-process sing-load data for each of a plurality of threads;
a bucket generator configured to generate a plurality of buckets, each of the buckets representing a normalized-load range;
a long-term load recorder configured to collect for each thread, long-term historical load data by increasing a count in a particular bucket each time the short-term-normalized-processing-load falls within a range of the particular bucket and decreasing a count in all other buckets of the plurality of buckets; and
an anticipated load module configured to predict a load based on an immediate load and the count in each of the plurality of buckets; and
an operating system configured to use the predicted load to manage processing capacity provided to process the thread.

8. The computing device of claim 7, wherein the short-term data recorder is configured to collect the short-term-normalized-processing-load data by determining a load of the thread during a sample duration.

9. The computing device of claim 7, wherein the short-term data recorder is configured to collect the short-term-normalized-processing-load data by keeping a continuous load value that gradually accumulates every unit of time a thread is runnable and gradually decays every unit of time the thread sleeps.

10. The computing device of claim 7, wherein an amount of increase and an amount of decrease for the particular bucket is based upon the count in the particular bucket.

11. The computing device of claim 7, wherein the anticipated load module is configured to:
determine an initial bucket the immediate load falls into;
attempt to identify an expected bucket that is a lowest bucket that has a non-zero count and is greater than or equal to the initial bucket;
if no expected bucket is found, then select the immediate load as the predicted load;
if an expected bucket is found, then set the predicted load to at least a load that falls within the expected bucket.

12. The computing device of claim 11, wherein the anticipated load module is configured to set the predicted load to be greater than the load range of the expected bucket based on the counts in each of the plurality of buckets with a load range that is greater than that of the expected bucket.

13. A non-transitory, tangible computer readable storage medium, encoded with processor readable instructions to perform a method for managing processing capacity on a computing device, the method comprising:
creating, for a thread, a plurality of buckets, each of the buckets representing one of a plurality of normalized-load ranges;
obtaining a short-term-normalized-processing-load for the thread;
collecting long-term historical load data for the thread by increasing a count in a particular bucket of the plurality of buckets that has a normalized-load range that includes the short-term-normalized-processing-load and decreasing a count in all other buckets of the plurality of buckets;
predicting a load for a thread based on, at least, an immediate load and the count in each of the plurality of buckets; and
using the predicted load to manage processing capacity provided to process the thread.

14. The non-transitory, tangible computer readable storage medium of claim 13, wherein obtaining the short-term-normalized-processing-load data includes determining a load of the thread during a sample duration.

15. The non-transitory, tangible computer readable storage medium of claim of claim 13, wherein obtaining the short-term-normalized-processing-load data includes keeping a continuous load value that gradually accumulates every unit of time a thread is runnable and gradually decays every unit of time the thread sleeps.

16. The non-transitory, tangible computer readable storage medium of claim of claim 13, wherein an amount of increase and an amount of decrease for the particular bucket is based upon the count in the particular bucket.

17. The non-transitory, tangible computer readable storage medium of claim of claim 13, wherein predicting a load based on an immediate load and the long term historical data includes:
determining an initial bucket the immediate load falls into;
attempting to identify an expected bucket that is a lowest bucket that has a non-zero count and is greater than or equal to the initial bucket;
if no expected bucket is found, then selecting the immediate load as the predicted load;
if an expected bucket is found, then setting the predicted load to at least a load that falls within the expected bucket.

18. The non-transitory, tangible computer readable storage medium of claim of claim 17,
wherein setting the predicted load includes setting the predicted load to be greater than the load range of the expected bucket based on the counts in each of the plurality of buckets with a load range that is greater than that of the expected bucket.
